(19) United States
(12) Patent Application Publication
(10) Pub. No.: US 2026/0093689 A1
(43) Pub. Date: Apr. 2, 2026

(54) DATA ANALYSIS METHOD, ELECTRONIC DEVICE, AND STORAGE MEDIUM

(71) Applicant: Beijing Volcano Engine Technology Co., Ltd., Beijing (CN)

(72) Inventors: Yingjie LI, Beijing (CN); Yuxuan HE, Beijing (CN); Lingmin XU, Beijing (CN); Minsheng HAN, Beijing (CN); Songming CHEN, Beijing (CN); Zhaojun LIANG, Beijing (CN); Chenying WANG, Beijing (CN); Yuan ZHANG, Beijing (CN); Peng ZHOU, Beijing (CN); Guokai HUANG, Beijing (CN); Xin LI, Beijing (CN); Yulin ZHU, Beijing (CN)

(21) Appl. No.: 19/341,906

(22) Filed: Sep. 26, 2025

(30) Foreign Application Priority Data
Sep. 27, 2024 (CN) 202411364988.X

(51) Int. Cl. G06F 16/242; G06F 16/248

(52) U.S. Cl. CPC G06F 16/2428; G06F 16/2425; G06F 16/243; G06F 16/248

(57) ABSTRACT

The present disclosure provides a data analysis method and apparatus, an electronic device, a storage medium, and a program product. The method includes: displaying a data analysis page, where an analysis control is displayed on the data analysis page, and the analysis control corresponds to at least one language model; determining a target language model in response to a selection instruction for the analysis control; generating a first data analysis instruction in response to a first question determined on the data analysis page, where the first data analysis instruction is used to determine a first analysis result of the target language model for the first question; and displaying the first analysis result on the data analysis page.

### CROSS-REFERENCE TO RELATED APPLICATION

The present application claims the priority to Chinese Patent Application No. 202411364988.X, filed on Sep. 27, 2024, the entire disclosure of which is incorporated herein by reference as portion of the present application.

### TECHNICAL FIELD

The present disclosure relates to a data analysis method and apparatus, an electronic device, a storage medium, and a program product.

### BACKGROUND

Currently, more and more natural language processing technologies are integrated into data consumption tools to provide more intelligent data analysis and prediction capabilities, and some data analysis tools start to provide more advanced data analysis functions such as prediction modeling and natural language querying. In the related art, these data analysis tools mainly use conversational analysis. However, because the caliber of the field of data analysis is complex, the questions input by the user are a group of expressions that are very similar in the data table, and different data analysis tools may have different understandings of the same question, resulting in a low accuracy of data analysis.

### SUMMARY

The present disclosure provides a data analysis method and apparatus, an electronic device, a storage medium, and a program product.

In a first aspect, the present disclosure provides a data analysis method, including:
displaying a data analysis page, where an analysis control is displayed on the data analysis page, and the analysis control corresponds to at least one language model;
determining a target language model in response to a selection instruction for the analysis control;
generating a first data analysis instruction in response to a first question determined on the data analysis page, where the first data analysis instruction is used to determine a first analysis result of the target language model for the first question; and
displaying the first analysis result on the data analysis page.

In a second aspect, the present disclosure provides a data analysis apparatus, including:
a first display module, configured to display a data analysis page, where an analysis control is displayed on the data analysis page, and the analysis control corresponds to at least one language model;
a model selection module, configured to determine a target language model in response to a selection instruction for the analysis control;
a first analysis module, configured to generate a first data analysis instruction in response to a first question determined on the data analysis page, where the first data analysis instruction is used to determine a first analysis result of the target language model for the first question; and
a second display module, configured to display the first analysis result on the data analysis page.

In a third aspect, the present disclosure provides an electronic device including a memory and a processor. The memory and the processor are in communication connection with each other. The memory stores computer instructions. The processor executes the computer instructions to perform the data analysis method according to the first aspect.

In a fourth aspect, the present disclosure provides a non-transitory computer-readable storage medium having computer instructions stored thereon. The computer instructions are used to enable a computer to perform the data analysis method according to the first aspect.

In a fifth aspect, the present disclosure provides a computer program product including computer instructions. The computer instructions are used to enable a computer to perform the data analysis method according to the first aspect.

### BRIEF DESCRIPTION OF DRAWINGS

To illustrate the technical solutions in the embodiments of the present disclosure more clearly, the drawings that are required to be used in the description of the specific embodiments will be briefly introduced below. Obviously, the drawings in the following description are some embodiments of the present disclosure. For those of ordinary skills in the art, other drawings can also be obtained from these drawings without creative efforts.

FIG. 1 is a schematic flowchart of a data analysis method according to an embodiment of the present disclosure;

FIG. 2 is a schematic diagram of a first data analysis page according to an embodiment of the present disclosure;

FIG. 3 is a schematic diagram of a second data analysis page according to an embodiment of the present disclosure;

FIG. 4 is a schematic diagram of a third data analysis page according to an embodiment of the present disclosure;

FIG. 5 is a schematic diagram of a fourth data analysis page according to an embodiment of the present disclosure;

FIG. 6 is a schematic diagram of a fifth data analysis page according to an embodiment of the present disclosure;

FIG. 7 is a schematic diagram of a first question optimization according to an embodiment of the present disclosure;

FIG. 8 is a schematic diagram of a second question optimization according to an embodiment of the present disclosure;

FIG. 9 is a schematic diagram of a third question optimization according to an embodiment of the present disclosure;

FIG. 10 is a schematic diagram of a sixth data analysis page according to an embodiment of the present disclosure;

FIG. 11 is a schematic diagram of a details page according to an embodiment of the present disclosure;

FIG. 12 is a schematic diagram of another details page according to an embodiment of the present disclosure;

FIG. 13 is a schematic diagram of a seventh data analysis page according to an embodiment of the present disclosure;

FIG. 14 is a schematic diagram of an eighth data analysis page according to an embodiment of the present disclosure;

FIG. 15 is a schematic diagram of a ninth data analysis page according to an embodiment of the present disclosure;

FIG. 16 is a schematic diagram of a task subscription page according to an embodiment of the present disclosure;

FIG. 17 is a schematic diagram of data pushing according to an embodiment of the present disclosure;

FIG. 18 is a schematic diagram of a tenth data analysis page according to an embodiment of the present disclosure;

FIG. 19 is a schematic diagram of a storage result according to an embodiment of the present disclosure;

FIG. 20 is a block diagram of a data analysis apparatus according to an embodiment of the present disclosure; and

FIG. 21 is a block diagram of an electronic device according to an embodiment of the present disclosure.

### DETAILED DESCRIPTION

To make the objectives, technical solutions, and advantages of the embodiments of the present disclosure clearer, the technical solutions in the embodiments of the present disclosure will be described clearly and comprehensively below with reference to the drawings in the embodiments of the present disclosure. Obviously, the described embodiments are part of the embodiments of the present disclosure, but not all of them. Based on the embodiments in the present disclosure, all other embodiments obtained by those of ordinary skills in the art without creative efforts shall fall within the protection scope of the present disclosure.

It can be understood that, before using the technical solutions disclosed in the embodiments of the present disclosure, the user shall be informed of the type, scope of use, use scenario, etc. of the personal information involved in the present disclosure in an appropriate manner in accordance with relevant laws and regulations and the user's authorization shall be obtained.

For example, in response to receiving an active request from the user, prompt information is sent to the user to explicitly prompt the user that the operation requested to be performed will require the acquisition and use of the user's personal information. Therefore, the user can independently select, according to the prompt information, whether to provide personal information to the software or hardware such as an electronic device, an application, a server, or a storage medium that performs the operation of the technical solution of the present disclosure.

As an optional but non-limiting implementation, a manner of sending the prompt information to the user in response to receiving the active request from the user may be, for example, a pop-up window, and the prompt information may be presented in the pop-up window in the form of text. In addition, the pop-up window may also carry a selection control for the user to select “agree” or “disagree” to provide personal information to the electronic device.

It can be understood that the above process of notification and acquisition of user authorization is only illustrative, and does not constitute a limitation on the implementations of the present disclosure. Other manners that satisfy relevant laws and regulations may also be applied to the implementations of the present disclosure.

Currently, more and more natural language processing technologies are integrated into data analysis tools to provide more intelligent data analysis and prediction capabilities, and some data analysis tools start to provide more advanced data analysis functions such as prediction modeling and natural language querying. In the related art, these data analysis tools mainly use conversational analysis. However, because the caliber of the field of data analysis is complex, the questions input by the user are a group of expressions that are very similar in the data table, and different data analysis tools may have different understandings of the same question, resulting in a low accuracy of data analysis.

In view of this, according to the embodiments of the present disclosure, an embodiment of a data analysis method is provided. It should be noted that the steps shown in the flowcharts of the drawings may be performed in a computer system such as a set of computer-executable instructions, and although a logical order is shown in the flowcharts, in some cases, the steps shown or described may be performed in an order different from that here.

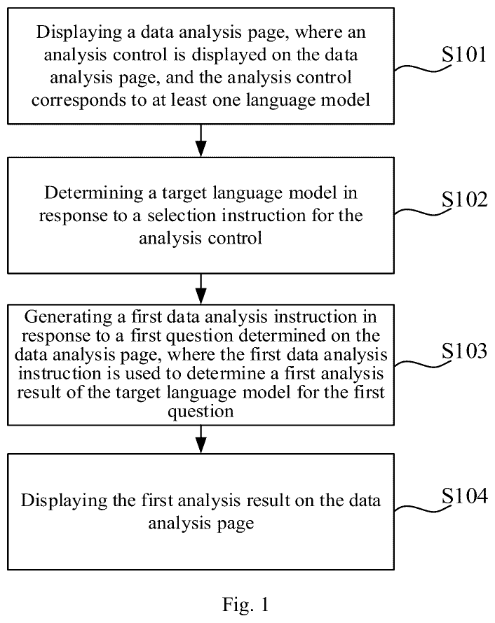

In this embodiment, a data analysis method is provided, which can be used for a data analysis platform. FIG. 1 is a schematic flowchart of a data analysis method according to an embodiment of the present disclosure. As shown in FIG. 1, the process includes the following steps.

Step S101: displaying a data analysis page, where an analysis control is displayed on the data analysis page, and the analysis control corresponds to at least one language model.

Specifically, analysis controls corresponding to different language models are displayed on the data analysis page, and a language model suitable for the current data analysis scenario can be adopted by selecting a analysis control to perform data analysis.

Step S102: determining a target language model in response to a selection instruction for the analysis control.

Specifically, in response to the selection instruction for the analysis control, the language model corresponding to the selected analysis control is determined as the target language model.

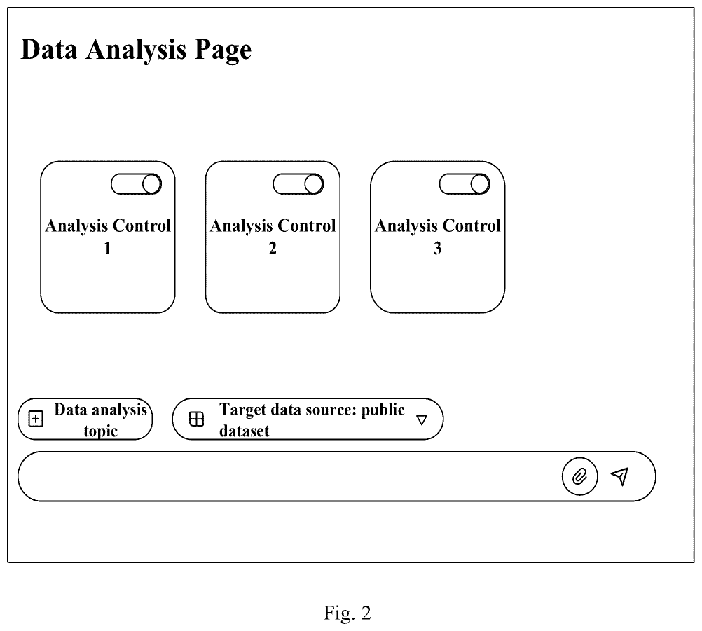

Specifically, the user can select language models with different functions from a language model repository, and the analysis control corresponding to each language model is displayed on the data analysis page. For example, as shown in FIG. 2, the data analysis page is displayed with an analysis control 1, an analysis control 2, and an analysis control 3. In addition, model information of the language model corresponding to the analysis control is also displayed in the region corresponding to the analysis control, so as to select, from the displayed analysis controls, the analysis control used in the current data analysis, thereby determining the language model used in the current data analysis. The user can switch or add the analysis controls corresponding to different language models at any time during the data analysis process.

Step S103: generating a first data analysis instruction in response to a first question determined on the data analysis page, where the first data analysis instruction is used to determine a first analysis result of the target language model for the first question.

Specifically, a target data source for data analysis is displayed on the data analysis page, and the first analysis result is obtained by performing data analysis based on the target language model, the target data source, and the first question.

Step S104: displaying the first analysis result on the data analysis page.

Specifically, the first analysis result is displayed in the form of a conversation on the data analysis page. If the selected analysis control corresponds to a plurality of language models, a conversation group is built based on the plurality of language models, and the first question is answered by the plurality of language models at the same time.

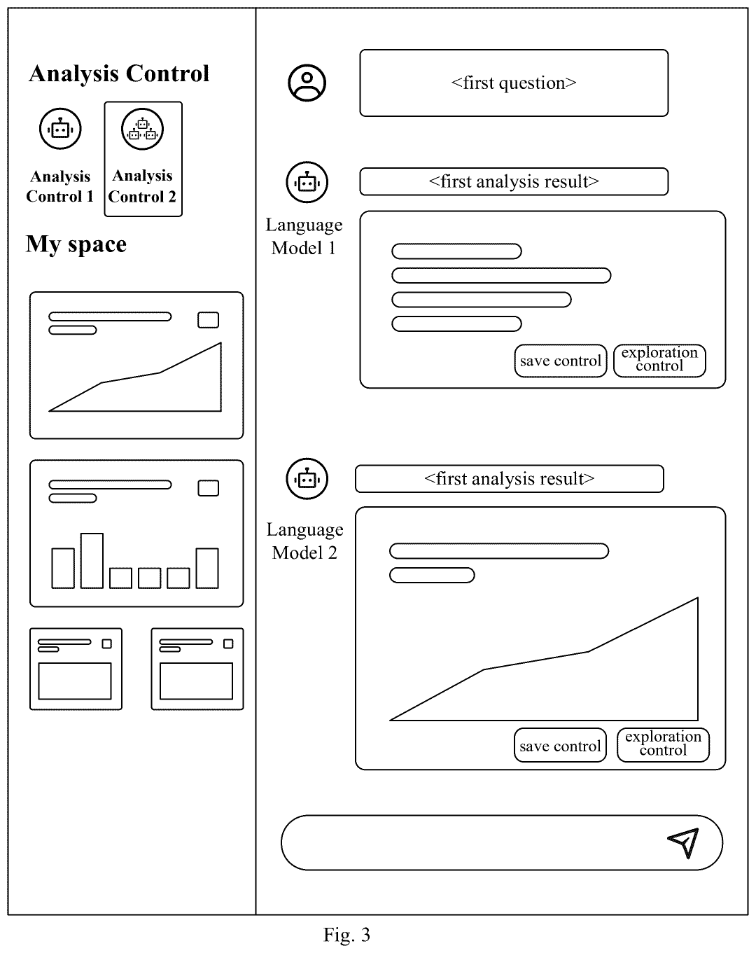

Exemplarily, as shown in FIG. 3, assuming that the analysis control 2 corresponds to a language model 1 and a language model 2, the first question is answered by the language model 1 and the language model 2 at the same time, and first analysis results of the language model 1 and the language model 2 for the first question are displayed on the data analysis page.

In the data analysis method provided in this embodiment, the analysis control corresponding to the at least one language model is displayed on the data analysis page. Therefore, the language model suitable for different data analysis scenarios can be provided through the analysis control. Furthermore, the language model corresponding to the selected analysis control is determined as the target language model, and the first analysis result of the target language model for the first question is determined and displayed. Therefore, the target language model adapted to the current data analysis scenario can be selected for data analysis to improve the accuracy of data analysis.

In some optional implementations, a target data source for data analysis and a recommended question corresponding to the target data source are further displayed on the data analysis page. In this case, the generating a first data analysis instruction in response to a first question determined on the data analysis page in step S103 includes the following steps.

Step a1: determining the first question in response to a selection instruction for the recommended question.

Specifically, the selected recommended question is determined as the first question.

Specifically, an appealing question is provided for the target data source, and the user is guided to perform data analysis through such a question, so as to master the use skills of the data analysis platform configured with the data analysis method of the present disclosure and improve the quality of data analysis services.

Further, on the one hand, a public dataset may be selected as the target data source, and an appealing question is provided for the public dataset to guide the user to perform data analysis. On the other hand, for different user roles or access permissions, a permission dataset related to the service is prepared in advance, and an appealing question is recommended to guide the user to perform data analysis. For example, for an operation user, recommended questions such as service core indicators and frequently asked operation questions may be provided to guide the operation user to perform data analysis.

Step a2: generating the first data analysis instruction in response to the determined first question.

In the data analysis method provided in this embodiment, the target data source and the corresponding recommended question are displayed on the data analysis page, and the first question is determined by selecting the recommended question. Therefore, guidance can be provided for data analysis, the difficulty of performing data analysis can be reduced, and the accuracy of the input question can be improved, so as to improve the accuracy of data analysis.

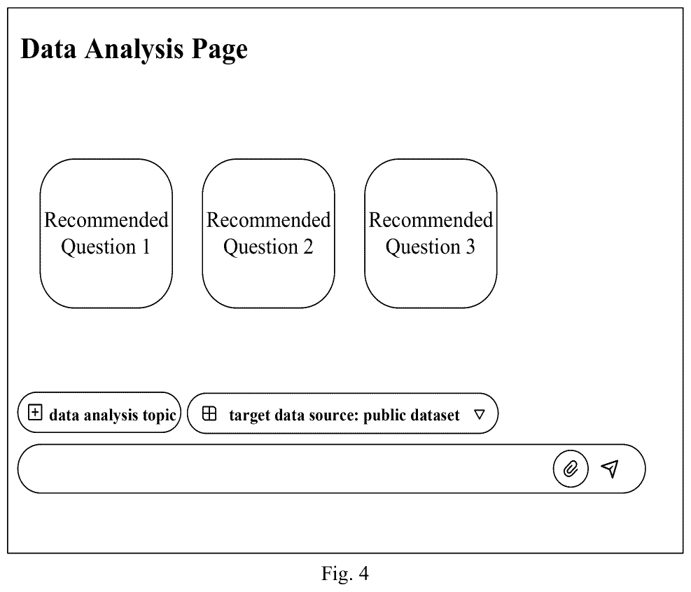

Exemplarily, as shown in FIG. 4, the target data source is displayed on the data analysis page. For example, the target data source is a public dataset, and recommended question 1, recommended question 2, and recommended question 3 may be provided based on the public dataset. The selected recommended question is determined as the first question, so as to generate the first data analysis instruction based on the first question.

In some optional implementations, the data analysis method of the present disclosure further includes the following steps.

Step b1: displaying an optional dataset in response to an interactive operation for the target data source, where the optional dataset includes at least one of a public dataset and other permission datasets with access permission.

Optionally, the optional dataset may also include other datasets without access permission. A region of the data analysis page corresponding to the other datasets displays a permission request control, and the permission request control is used to apply for access permission of the corresponding other datasets. Alternatively, a request instruction is generated in response to an interactive operation for the other datasets, and the request instruction is used to apply for access permission of the other datasets.

Step b2: updating the target data source with a selected optional dataset in response to a selection instruction for the optional dataset.

Specifically, a selection instruction is generated in response to a selection operation for the optional dataset, and the selection instruction is used to determine the selected optional dataset. The target data source is updated with the selected optional dataset.

It is worth noting that, to ensure data security, the data of the data analysis platform needs to be enabled with permission to use, which makes it difficult for some users to quickly perform data analysis due to their unfamiliarity with the data analysis process. Therefore, providing the fallback public dataset can guide the user to quickly perform data analysis and improve the efficiency of data analysis.

In the data analysis method provided in this embodiment, the optional dataset including at least one of the public dataset and other permission datasets with access permission is displayed. The target data source is updated with the selected optional dataset. Therefore, on the one hand, the public dataset can be provided as the fallback data for data analysis, so as to avoid the situation that the analysis result of the question cannot be generated, and the effect of data analysis is improved. On the other hand, the optional dataset is provided to switch the target data source, so that data from different sources can be explored, changes in data analysis requirements can be adapted to, and the generalization ability of data analysis can be improved.

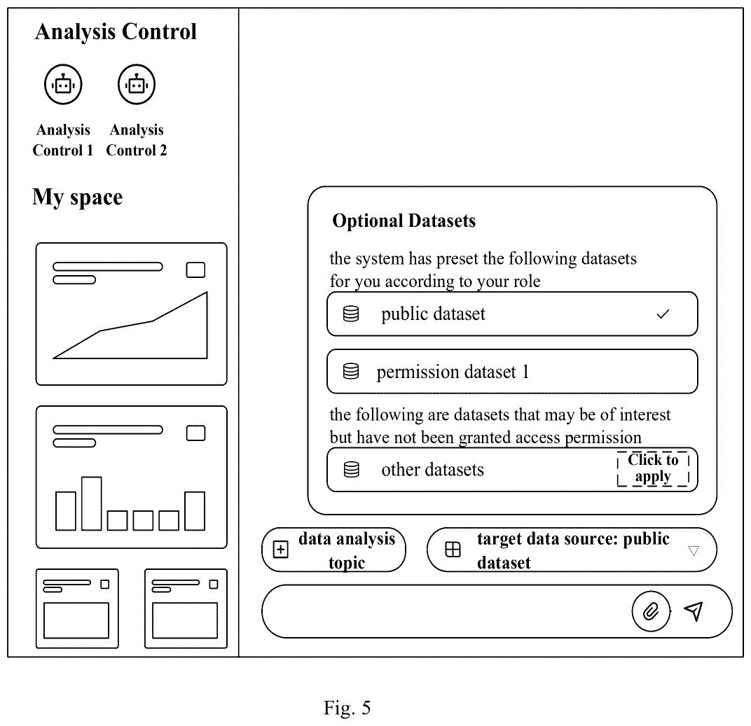

Exemplarily, as shown in FIG. 5, assuming that the optional datasets include a public dataset, a permission dataset 1, and other datasets without access permission, other datasets that cannot be accessed can be distinguished from the accessible public dataset and permission dataset by prompt words of “the following are datasets that may be of interest but have not been granted access permission” and “the system has preset the following datasets for you according to your role”. As shown in FIG. 5, assuming that the selected optional dataset is the public dataset, the public dataset is displayed in the region corresponding to the target data source to prompt the user of the dataset currently used.

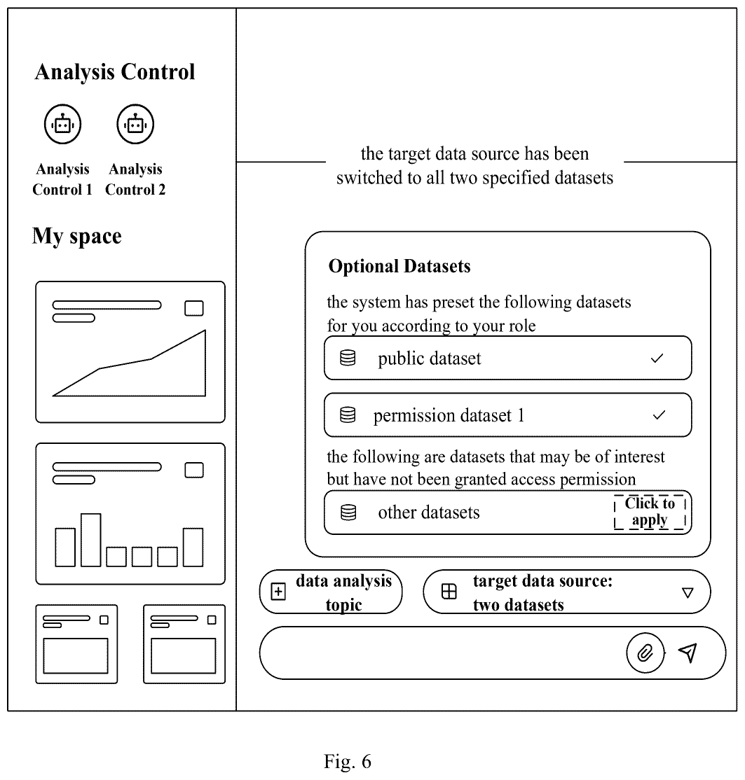

Exemplarily, as shown in FIG. 6, in the case where the number of selected optional datasets is greater than 1, the number of selected datasets is displayed in the region of the data analysis page corresponding to the target data source. For example, if the public dataset and the permission dataset 1 are selected as the target data source, two datasets are displayed. In addition, the switching of the dataset of the target data source will be explicitly prompted in the conversation flow. Specifically, a prompt word indicating that the target data source has been successfully updated is displayed on the data analysis page, for example, “the target data source has been switched to all two specified datasets”.

In some optional implementations, a new topic control (see data analysis topics shown in FIG. 5 and FIG. 6) is further displayed on the data analysis page, and the new topic control is used to add a new data analysis topic.

In other optional implementations, the generating a first data analysis instruction in response to a first question determined on the data analysis page in S103 includes the following steps.

Step c1: determining an initial question in response to a question input into an input control on the data analysis page.

For example, if the question “what is the sales volume?” is input into the input control on the data analysis page, “what is the sales volume?” is determined as the initial question.

Step c2: determining the first question in response to an optimization instruction for the initial question.

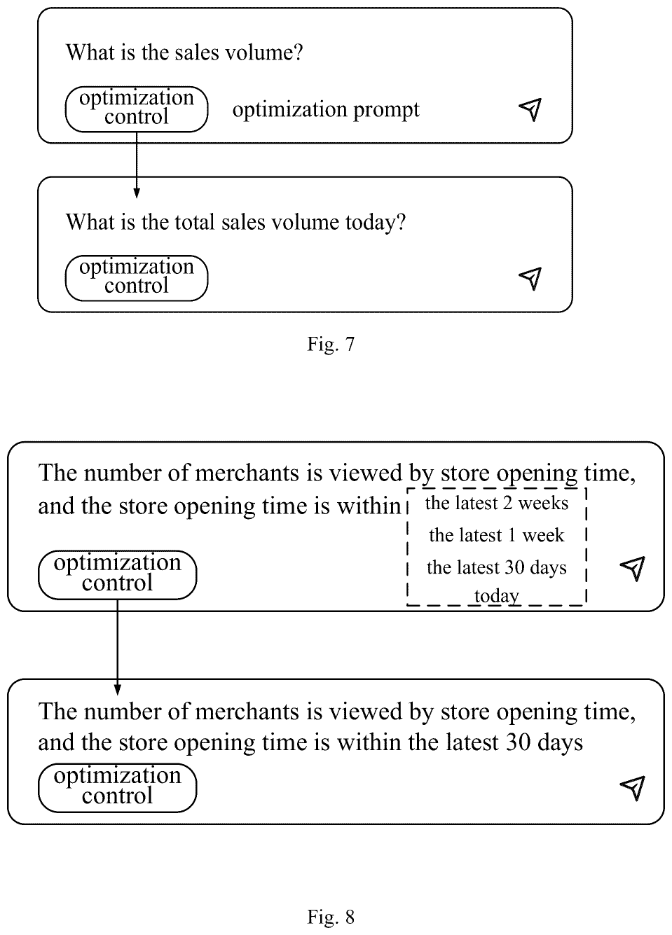

In some optional implementations, as shown in FIG. 7, an optimization control is displayed in the region where the input control on the data analysis page is located, and the optimization control is used to optimize the initial question to determine the first question. An optimization prompt is also displayed in the region where the input control is located with the input operation of the user to guide the user to optimize the initial question.

Optionally, the step c2 includes: generating the optimization instruction in response to an interactive operation on the optimization control to determine the first question.

For example, as shown in FIG. 7, “what is the sales volume?” is optimized to obtain the first question “what is the total sales volume today?”, so as to improve the accuracy of the first question.

In other optional implementations, as shown in FIG. 8, with the input operation of the user, optional data corresponding to the target data in the initial question is also displayed in the region where the input control is located, and the initial question may be adjusted according to the optional data to determine the first question.

Optionally, the step c2 includes: determining the target data in the initial question in response to the question input into the input control on the data analysis page; displaying the optional data corresponding to the target data in the region of the data analysis page corresponding to the target data; and updating the target data with the selected optional data in response to a selection instruction for the optional data.

Specifically, the target data is data satisfying a preset condition, for example, data with a time attribute.

For example, as shown in FIG. 8, assuming that the initial question is “the number of merchants is viewed by store opening time, and the store opening time is within the latest 1 week”, optional data “latest 2 weeks”, “latest 30 days”, and “today” are provided for “latest 1 week”. If “latest 30 days” is selected, the first question is determined as “the number of merchants is viewed by store opening time, and the store opening time is within the latest 30 days”.

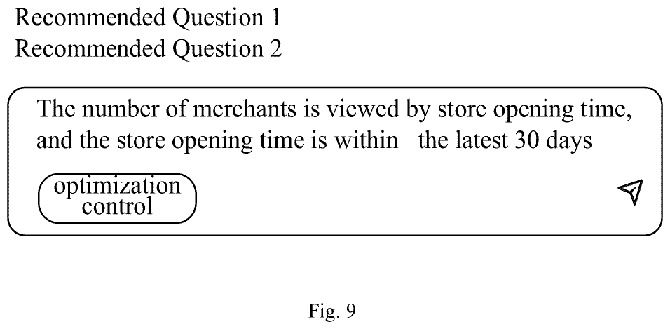

In other optional implementations, as shown in FIG. 9, recommended questions such as recommended question 1 and recommended question 2 are displayed in the region of the data analysis page corresponding to the initial question, and the user can select the recommended questions to update the initial question, so as to determine the first question.

Optionally, the step c2 includes: displaying the recommended questions on the data analysis page; and generating the optimization instruction in response to a selection instruction for the recommended questions to determine the first question.

Step c3: generating the first data analysis instruction in response to the determined first question.

In the data analysis method provided in this embodiment, the first question is determined in response to the optimization instruction for the input initial question. Then, the first data analysis instruction is generated based on the first question. Therefore, the accuracy of the first question can be improved, thereby further improving the accuracy of data analysis.

It is worth noting that in the data analysis method of the present disclosure, the predicted recommended questions may be displayed to determine the first question. In addition, with the input operation of the user in the input control on the data analysis page, keywords (i.e., optional data) are predicted and recommended in combination with operation data, etc., to determine the first question. In addition, the input question may also be optimized through the optimization control to determine the first question. Therefore, the user can be guided to describe the question in a natural language, and the accuracy of data analysis can be improved.

In some optional implementations, during the process of determining the first analysis result, a data analysis process of the target language model for the first question is displayed on the data analysis page.

Specifically, during the process of determining the first analysis result of the target language model for the first question, the data analysis process of the target language model for the first question may be displayed. The data analysis process includes at least one hierarchical data analysis element. The at least one hierarchical data analysis element includes at least one of: searching a specified dataset, searching a specified dimension, searching a specified indicator, and searching a filter item. Therefore, the visualization of the data analysis process can be realized.

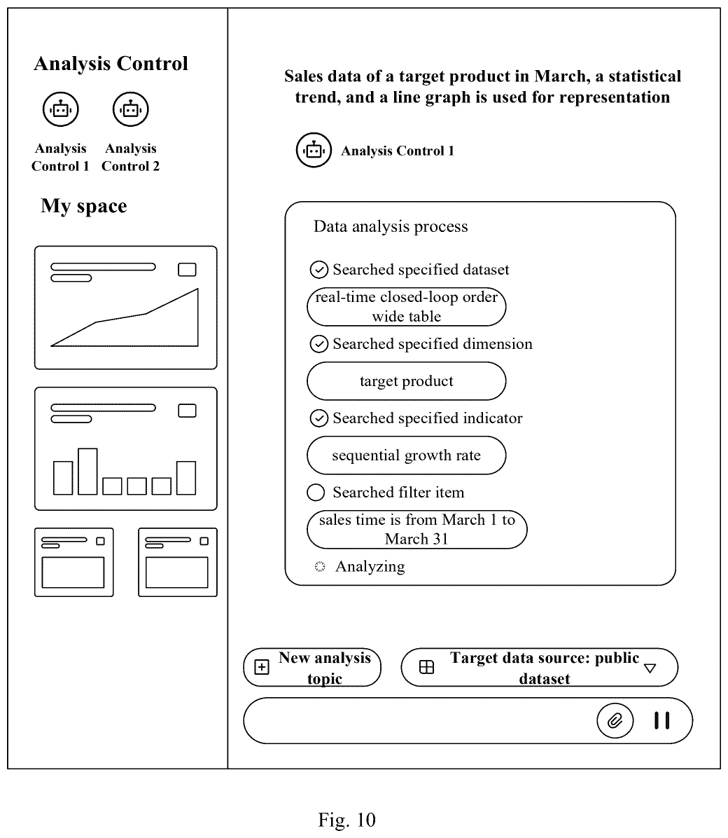

Exemplarily, as shown in FIG. 10, taking the case that the first question is “sales data of a target product in March, a statistical trend, and a line graph is used for representation”, and the target language model is a language model corresponding to the analysis control 1 as an example, the data analysis process of the target language model for the first question is displayed during the process of determining the first analysis result of the target language model for the first question. For example, the searched specified dataset is “real-time closed-loop order wide table”, the searched specified dimension is “target product”, the searched specified indicator is “sequential growth rate”, and the searched filter item is “sales time is from March 1 to March 31”. The status of the data analysis step corresponding to each data analysis element is displayed. In addition, a pause control is displayed in the region of the data analysis page corresponding to the input control. The data analysis of the target language model for the first question may be paused in response to an interactive operation of the pause control. Furthermore, a modified data analysis element may be determined in response to a modification operation for the data analysis element. Then, data analysis is performed again according to the modified data analysis element to obtain the corresponding analysis result.

In the data analysis method provided in this embodiment, the data analysis process of the target language model for the first question is displayed on the data analysis page. Therefore, the visualization of the data analysis process can be realized, and the experience of the data analysis service can be improved. In addition, it is convenient to modify the data analysis element with problems in the data analysis process, so as to further improve the accuracy of the data analysis result.

It is worth noting that after the user selects or inputs the question to determine the first question, the data analysis process of the target language model for the first question is entered. The data analysis process of the target language model is displayed through a dynamic effect on the data display page. Then, the data analysis process is presented by means of information visualization. In the data analysis process, the user can also interrupt the data analysis process and modify the data analysis elements to re-analyze the first question.

In some optional implementations, a viewing control is further displayed in the region of the data analysis page corresponding to the first analysis result, the viewing control is used to view the data analysis process of the first analysis result, and the data analysis process includes at least one hierarchical data analysis element.

It should be noted that the data analysis process of the first analysis result is consistent with the data analysis process of the first question.

In the data analysis method provided in this embodiment, the viewing control for viewing the data analysis process of the first analysis result is further displayed in the region of the data analysis page corresponding to the first analysis result. The data analysis process includes at least one hierarchical data analysis element. Therefore, it is convenient to understand the data analysis details of the first analysis result, so as to modify the data analysis elements with abnormalities in the data analysis process, thereby adjusting the first analysis result and improving the accuracy of data analysis.

In some optional implementations, the data analysis method of the present disclosure further includes the following steps.

Step d1: displaying at least one hierarchical data analysis element on a details page in response to an interactive operation on the viewing control.

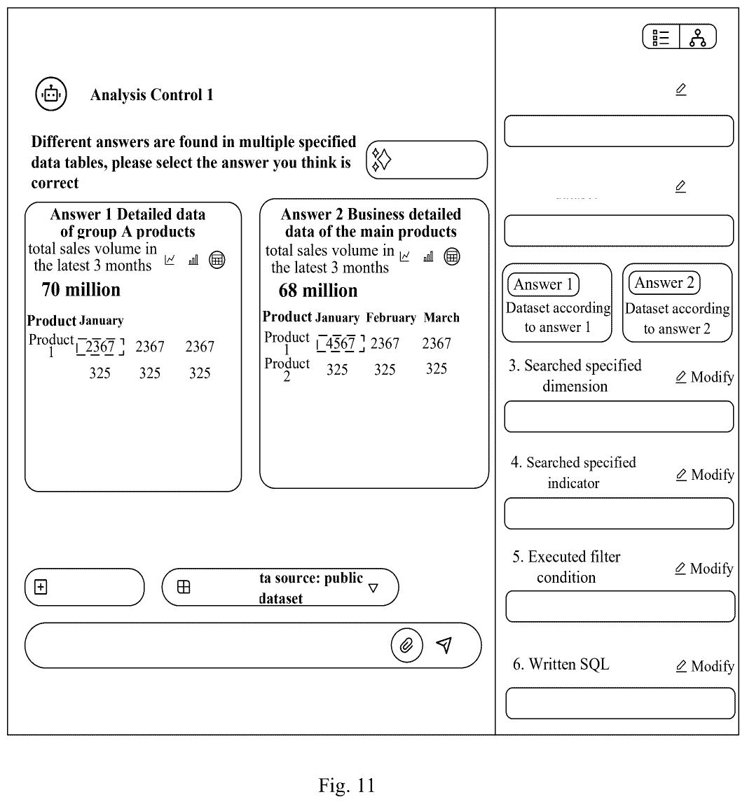

Specifically, the at least one hierarchical data analysis element includes at least one of: a raised question, a searched specified dataset, a searched specified dimension, a searched specified indicator, an executed filter condition, and a written Structured Query Language database (see written SQL shown in FIG. 11).

Step d2: determining a modified data analysis element in response to a modification instruction for the at least one hierarchical data analysis element.

Specifically, a modification control is displayed in the region of the details page corresponding to the data analysis element. A modification page is displayed in response to an interactive operation on the modification control. A modification instruction for the corresponding data analysis element is generated in response to a modification operation on the modification page, and the modification instruction is used to determine the modified data analysis element.

Step d3: displaying an analysis result corresponding to the modified data analysis element on the data analysis page.

Specifically, the analysis result corresponding to the modified data analysis element is determined in response to the modified data analysis element, and the analysis result is displayed on the data analysis page.

Specifically, the details page may be displayed on one side of the data analysis page through a display form such as a drawer or a pop-up window.

In the data analysis method provided in this embodiment, at least one hierarchical data analysis element in the data analysis process is displayed on the details page. Therefore, the visualization of the data analysis process can be realized, and the experience of the data analysis service can be improved. In addition, it is convenient to modify the data analysis element with problems in the data analysis process, so as to further improve the accuracy of the data analysis result.

Exemplarily, as shown in FIG. 11, assuming that the first analysis result includes answer 1 and answer 2, and it is prompted that “different answers are found in multiple specified data tables, please select the answer you think is correct”. Answer 1 is the detailed data of group A products, and answer 1 displays that “the total sales volume in the latest 3 months is 70 million. The sales volume of product 1 in January, February, and March is 2367. The sales volume of product 2 in January, February, and March is 325”. Answer 2 is the business detailed data of the main products, and answer 2 displays that “the total sales volume in the latest 3 months is 68 million. The sales volume of product 1 in January is 4567, and the sales volume of product 1 in February and March is 2367. The sales volume of product 2 in January, February, and March is 325” (the data shown in FIG. 11 is only an example). The two answers show different sales volumes of product 1 in January. A viewing control for viewing the data analysis process is displayed in the region of the data analysis page corresponding to the first analysis result (see “viewing the complete idea” shown in FIG. 11). A viewing instruction is generated in response to an interactive operation on the viewing control to display the details page. The details page displays the data analysis processes of the two answers, and the user can view the data analysis processes of the two answers or modify the data analysis elements in the data analysis processes to adjust the first analysis result of the first question.

In some optional implementations, at least one first display control is further displayed on the details page, and the first display control is used to determine a display manner of the at least one hierarchical data analysis element on the details page.

Specifically, the first display control corresponds to a display manner, and the display manner of the data analysis element can be switched by selecting the first display control. For example, the data analysis element is displayed through a display manner of a form or a tree graph.

In the data analysis method provided in this embodiment, the first display control is displayed on the details page to adjust the display manner of the data analysis element on the details page. Therefore, the display manner of the data analysis element can be flexibly adjusted, and the analysis idea represented by the data analysis process can be better displayed.

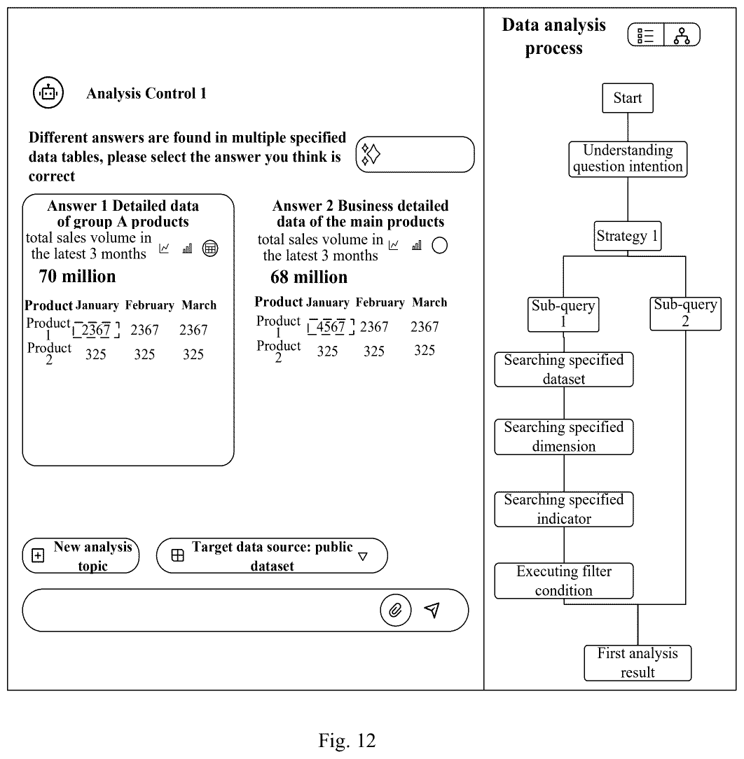

Exemplarily, as shown in FIG. 12, the data analysis element may be displayed in the display manner of a tree graph through the first display control. For example, from a node of “start” to a node of “understanding question intention”, and then a node of “strategy 1” is executed. A node of “sub-query 1” and a node of “sub-query 2” are differentiated from the node of “strategy 1”. A node of “searching specified dataset” is set under the node of “sub-query 1”. A node of “searching specified dimension” is set under the node of “searching specified dataset”. A node of “searching specified indicator” is set under the node of “searching specified dimension”. A node of “executing filter condition” is set under the node of “searching specified indicator”. Then, the node of “first analysis result” is reached. The node of “sub-query 2” directly reaches the node of “first analysis result”. The edge between the nodes of each data analysis element may display the data analysis time between the data analysis elements. For example, the data analysis time from the node of “searching specified dataset” to the node of “searching specified dimension” may be 1.3 s.

It can be understood that, for the answered question, the user can click on the viewing control to display the data analysis process, view the overall idea of the data analysis, or modify the data analysis element again.

In some optional implementations, the data analysis method of the present disclosure further includes the following steps.

Step e1: determining a target analysis object in response to a selection instruction for first data in the first analysis result and/or second data in a historical analysis result.

Specifically, if the first data in the first analysis result is selected, the first data is determined as the target analysis object. If the second data in the historical analysis result is selected, the second data is determined as the target analysis object.

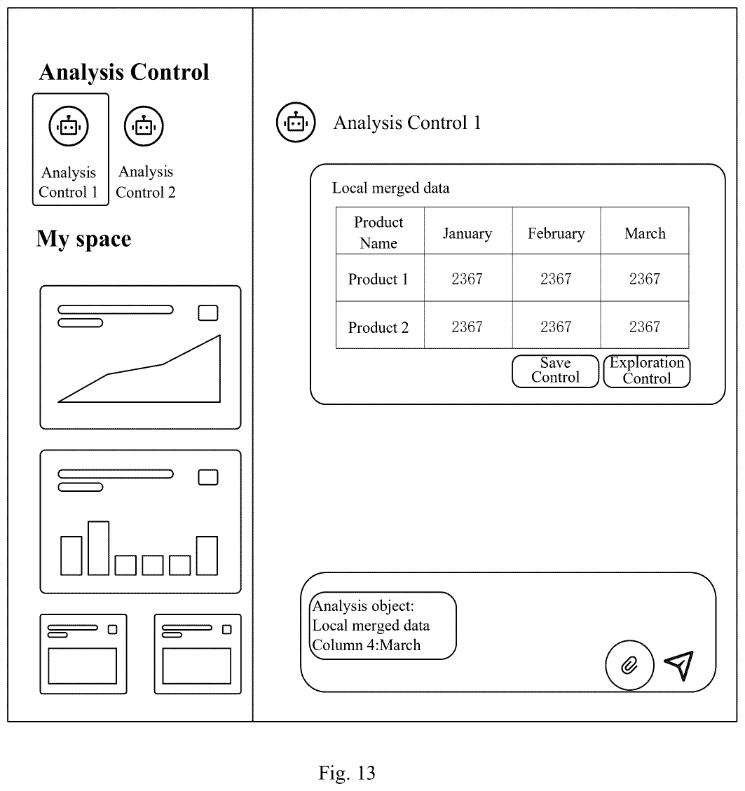

Specifically, for the data in the first analysis result and/or the historical analysis result, data corresponding to a column, a row, or a cell can be flexibly selected as the target analysis object. For example, as shown in FIG. 13, the data of product 1 and product 2 from January to March is displayed as 2367 in the local merged data. According to actual requirements, the data of March in the fourth column in the local merged data may be selected as the target analysis object.

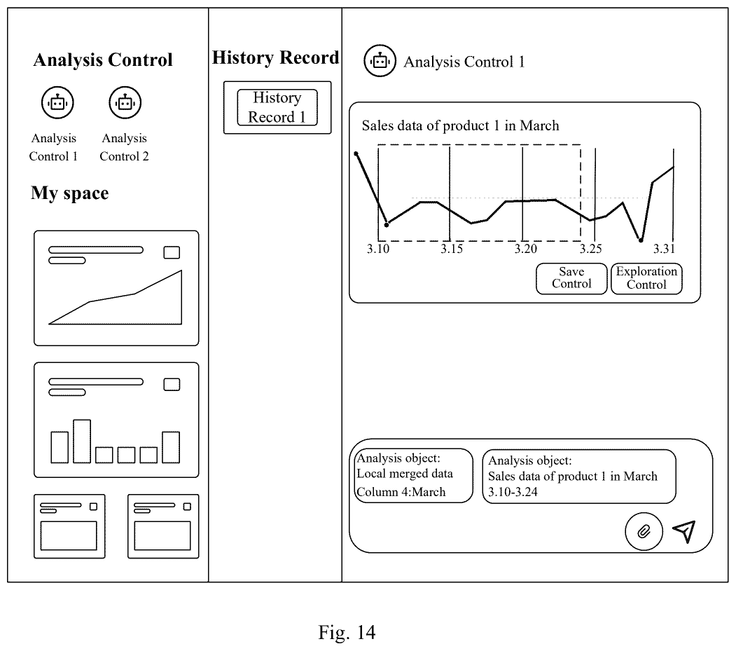

Specifically, the historical analysis record may be viewed by scrolling up or clicking on the history record control on the data analysis page, so as to select the target analysis object from the historical analysis record. For example, as shown in FIG. 14, data from 3.10 to 3.24 in the sales data of product 1 in March in history record 1 is selected as the target analysis object.

Further, the target analysis object is displayed on the data analysis page, for example, the target analysis object is displayed in the input control on the data analysis page, so as to facilitate the user to perform secondary query and analysis in a targeted manner.

Step e2: generating a second data analysis instruction in response to a second question input into the input control on the data analysis page, where the second data analysis instruction is used to determine a second analysis result of the target language model for the second question and the target analysis object.

Specifically, the second analysis result is obtained by performing data analysis on the target analysis object based on the target language model and the second question.

Step e3: displaying the second analysis result on the data analysis page.

In the data analysis method provided in this embodiment, the first data in the first analysis result and/or the second data in the historical analysis result are selected as the target analysis object. Then, the second data analysis instruction is generated based on the second question input into the input control on the data analysis page, so as to perform data analysis on the target analysis object to obtain the second analysis result. Therefore, the data analysis can be performed across data, and the flexibility of data analysis can be improved.

In some optional implementations, an upload control is further displayed on the data analysis page, and the upload control is used to upload a target content. The data analysis method of the present disclosure further includes the following steps.

Step f1: determining the target content in response to an interactive operation on the upload control.

Specifically, the uploaded content is determined as the target content in response to the interactive operation of uploading through the upload control.

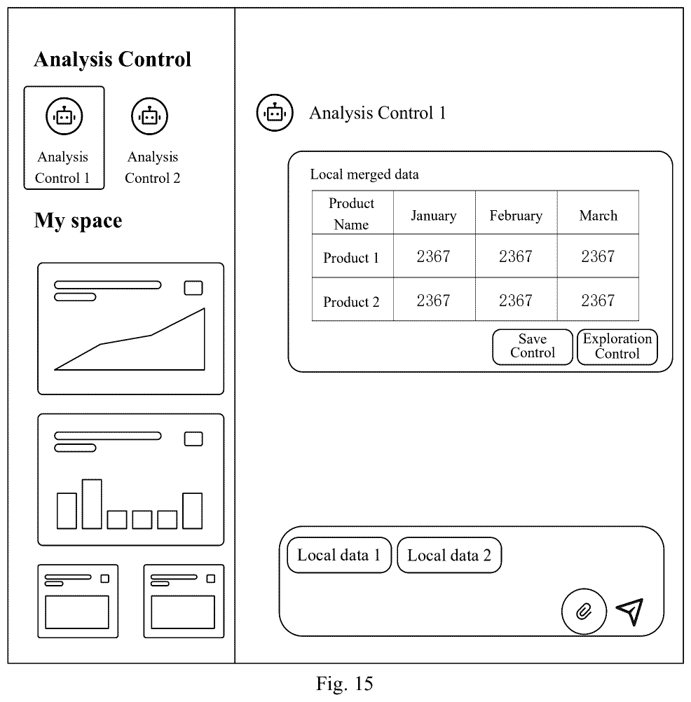

Exemplarily, as shown in FIG. 15, local data 1 and local data 2 may be uploaded through the upload control on the data analysis page. Therefore, data analysis can be performed on the basis of the local data 1 and the local data 2 to obtain the data analysis result.

Step f2: generating a third data analysis instruction in response to a third question input into the input control on the data analysis page, where the third data analysis instruction is used to determine a third analysis result of the target language model for the third question and the target content.

Specifically, the third analysis result is obtained by performing data analysis on the target content based on the target language model and the third question.

Step f3: displaying the third analysis result on the data analysis page.

In the data analysis method provided in this embodiment, the upload control is displayed on the data analysis page, and the upload control is used to upload the target content. Therefore, the upload control can be used to support the uploading of local data, so as to perform data analysis with the local data, thereby improving the flexibility of data analysis.

It can be understood that, for the analysis result given by the language model, the user can perform the combined query and processing across data, and the uploading of local files is also supported. Therefore, the flexibility of data analysis can be improved.

In some optional implementations, a save control is further displayed in the region of the data analysis page corresponding to the first analysis result, and the save control is used to store the first question and/or the first analysis result.

Specifically, the user can separately store the first question through the save control, or store the first question and the first analysis result at the same time. In addition, the first analysis result may be separately stored according to actual requirements.

In the data analysis method provided in this embodiment, the save control is displayed to store the first question and/or the first analysis result. Therefore, it is convenient for subsequent query of the data analysis result and further data analysis.

In some optional implementations, the data analysis method of the present disclosure further includes the following steps.

Step g1: displaying a task subscription page in response to an interactive operation on the save control, where the task subscription page is used to store the first question to obtain a target subscription task of the first question.

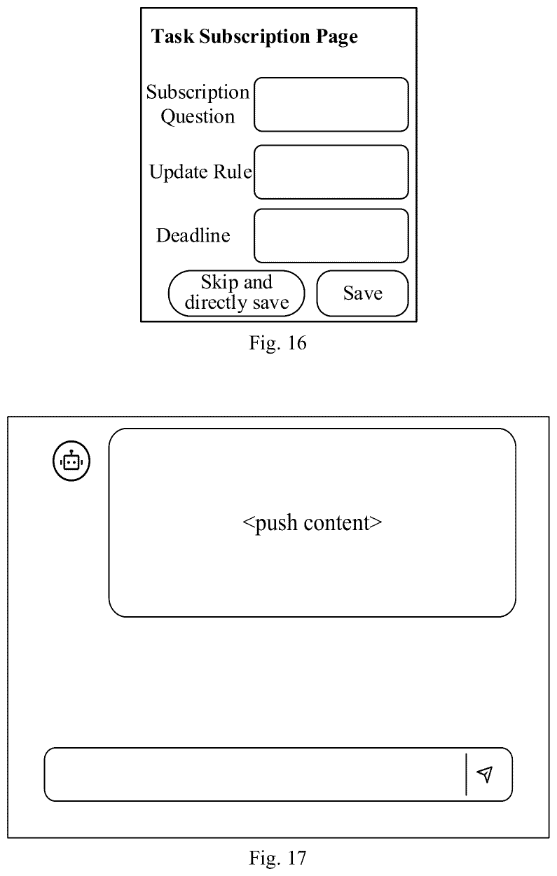

Specifically, as shown in FIG. 16, the task subscription page may be displayed through a display manner such as a floating layer or a pop-up window. At least one configuration item of a subscription question, an update rule, and a deadline of the subscription task is displayed on the task subscription page, where the subscription question may be configured with the first question to be stored. The target subscription task corresponding to the first question is determined in response to a configuration operation for the configuration item on the task subscription page. The user may save the target subscription task, or skip and directly save the first question.

Step g2: generating push content in response to a fourth analysis result fed back for the target subscription task.

Specifically, assuming that the update rule of the target subscription task is to update monthly, and the deadline is never due, the second analysis result of the target subscription task is obtained every month, and the push content is generated based on the second analysis result.

Step g3: pushing the push content to a target push object.

Specifically, the corresponding push content may be pushed to the target push object in manners such as email, document, and message card.

Exemplarily, as shown in FIG. 17, the corresponding push content may be pushed to the target push object in the form of a message card.

It can be understood that in the data analysis method of the present disclosure, the configuration items required by the subscription task corresponding to the first question and the first analysis result may be configured in advance, and the subscription for the first question and the first analysis result according to the configuration items is supported.

In the data analysis method provided in this embodiment, the task subscription page is displayed through the interactive operation on the save control, so as to store the first question and obtain the target subscription task corresponding to the first question. Furthermore, the push content corresponding to the target subscription task is pushed to the target push object. Therefore, the problem of temporary query can be converted into the requirement of routine query, and the data query efficiency of the problem of historical query can be improved. Furthermore, the first question and the first analysis result can also be stored for a long time for the next data analysis.

In some optional implementations, the data analysis page includes a first display region for displaying the first question and the first analysis result, and a second display region for displaying a storage result corresponding to the save control.

Specifically, the first question and the first analysis result are displayed in the form of a conversation in the first display region. Furthermore, the first display region also displays the content such as the data analysis topic, the target data source, and the data analysis process of the data analysis page. The storage result such as the stored question and analysis result is displayed in the second display region, which can be seen in the “my space” part in the drawings. Furthermore, the second display region also displays the analysis control.

In the data analysis method provided in this embodiment, the data analysis page is divided into the first display region for displaying the first question and the first analysis result, and the second display region for displaying the storage result corresponding to the save control. Therefore, the data analysis can be performed in conjunction with the storage result, so as to improve the flexibility of data analysis.

In some optional implementations, the data analysis method of the present disclosure further includes: displaying summary content of the selected storage result in the first display region in response to a selection instruction for the storage result.

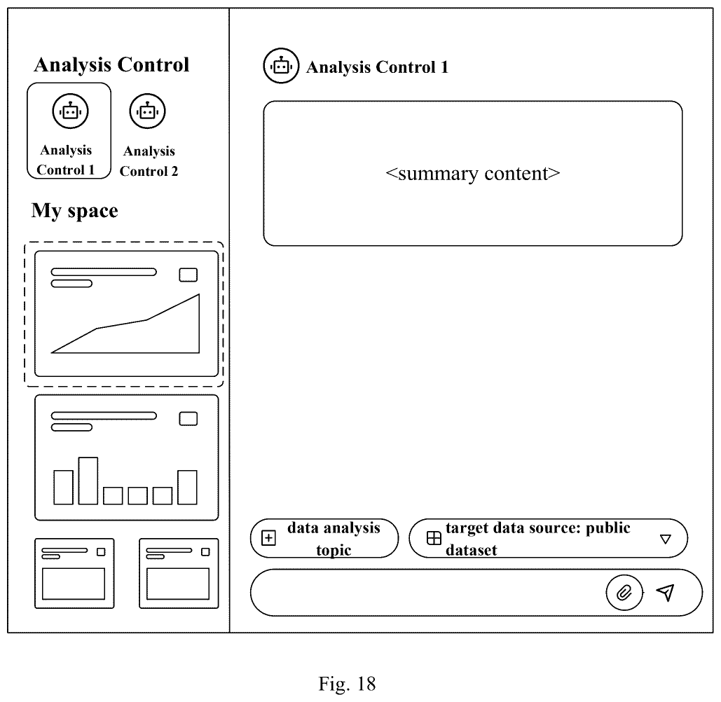

Specifically, as shown in FIG. 18, the user may select the storage result displayed in the second display region, and display the summary content of the selected storage result in the first display region, to implement data analysis of the favorited question and analysis result, so as to improve the query efficiency of the favorited query question and analysis result.

In the data analysis method provided in this embodiment, in the case where the storage result is selected, the summary content of the selected storage result is displayed in the first display region. Therefore, the query efficiency of the favorited query question and analysis result can be improved.

In some optional implementations, at least one second display control is displayed in the second display region, and the second display control is used to determine a display manner of the storage result in the second display region.

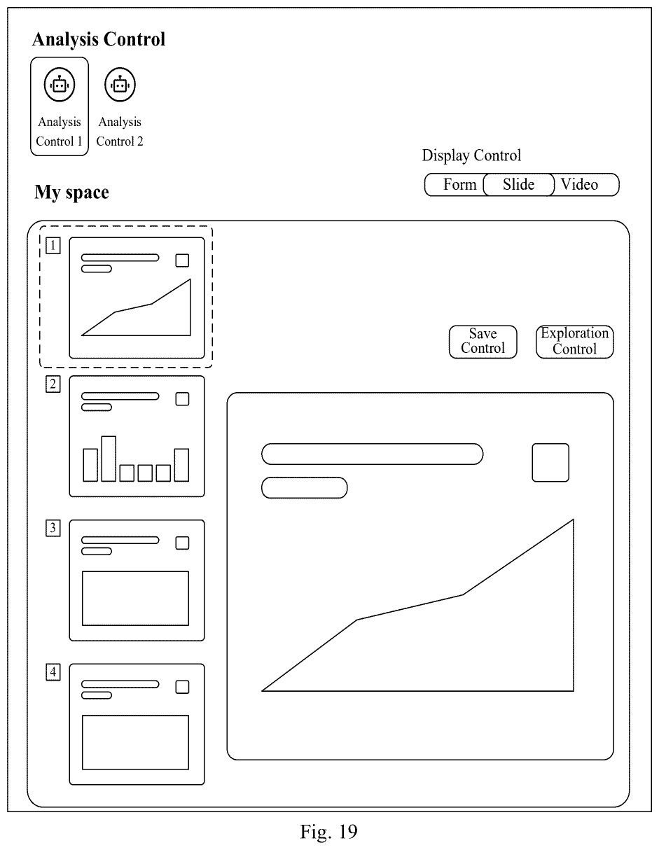

Specifically, each display control corresponds to a display manner, such as a display manner of a form, a slide, a video, or the like. The user can switch the display manner of the storage result through the display control. For example, as shown in FIG. 19, each storage result may be displayed in the display manner of a slide.

It should be noted that the display manner of a video may be to generate a video of the storage result in the form of automatically playing a slide to automatically play the storage result.

In the data analysis method provided in this embodiment, at least one second display control is displayed in the second display region, so that the display manner of the storage result can be flexibly adjusted, and the display effect of the data analysis result can be improved.

In some optional implementations, a download control is further displayed in the region of the second display region corresponding to the storage result, to download the storage result.

In some optional implementations, a share control is further displayed in the region of the second display region corresponding to the storage result, to share the storage result.

In some optional implementations, a download control is further displayed in the region of the data analysis page corresponding to the target analysis result, to download the first question and the target analysis result.

In some optional implementations, a share control is further displayed in the region of the data analysis page corresponding to the target analysis result, to share the first question and the target analysis result.

As a specific application example, a target program is installed on the data analysis platform, and the target program is used to perform data analysis by using the data analysis method of the present disclosure. The user can select, through the data analysis platform, the language model suitable for the current data analysis scenario to perform data analysis, so as to improve the accuracy of the data analysis result.

It is worth noting that in the data analysis method of the present disclosure, the language model suitable for different data analysis scenarios is provided through the analysis control for the user to select. Therefore, the appropriate language model can be selected for data analysis according to the requirements of the data analysis scenario, so as to be compatible with multiple data analysis scenarios. In addition, a plurality of language models may also be used in a data analysis scenario to provide natural language conversation analysis. The data analysis method of the present disclosure can be performed by the language models of a plurality of subdivision scenarios individually or in combination, and therefore, the flexible switching of the data analysis scenario can be realized. Furthermore, in the data analysis method of the present disclosure, through continuous questioning and favoriting, a personalized data analysis platform is created, which can realize the precipitation, analysis, collaboration and reporting of analysis assets.

In some optional implementations, an exploration control is displayed in the region of the data analysis page corresponding to the first analysis result. The data analysis method of the present disclosure further includes: displaying a visualization canvas of the first analysis result on an exploration analysis page in response to an interactive operation on the exploration control, to obtain an exploration analysis result of the first analysis result, where the visualization canvas is used to provide a data processing environment of the first analysis result; and displaying the exploration analysis result on the data analysis page in response to an interactive operation on a return control on the exploration analysis page.

In some optional implementations, an upload control is further displayed on the exploration analysis page, and the upload control on the exploration analysis page is used to upload analysis content. The data analysis method of the present disclosure further includes: displaying the analysis content on the visualization canvas in response to an interactive operation on the upload control; and associating the first analysis result with the analysis content in response to an association operation for the first analysis result and the analysis content, to obtain the exploration analysis result.

In some optional implementations, the first analysis result includes first analysis data of at least one hierarchical dimension. The data analysis method of the present disclosure further includes: obtaining second analysis data obtained by disassembling the first analysis data in response to a disassembly instruction for the first analysis data in the visualization canvas, to obtain the exploration analysis result, where the exploration analysis result is obtained based on the first analysis data and the second analysis data.

In some optional implementations, an analysis control is further displayed on the exploration analysis page, and the analysis control is used to call a conversation page corresponding to a language model linked with the visualization canvas. The data analysis method of the present disclosure further includes: displaying a conversation page in response to an interactive operation on the second analysis control; and generating an operation instruction in response to a fourth question input into the conversation page, where the operation instruction is generated based on the language model linked with the visualization canvas and the fourth question, and the operation instruction is used to perform a target operation on the first analysis result in the visualization canvas.

Specifically, the target operation includes at least one of: adding a data node of the first analysis result, explaining the first analysis result or the first analysis data, disassembling the first analysis data, or summarizing the content in the visualization canvas. In addition, other operations for the first analysis result, the target content, the first analysis data, or the second analysis data in the visualization canvas are also included, which will not be limited here. Therefore, the linkage between the language model and the visualization canvas can be realized.

It should be noted that the analysis control on the exploration analysis page may be the same as the analysis control on the data analysis page. That is, the language model linked with the exploration analysis page may be the same as the language model linked with the data analysis page, or other language models may be used, which will not be limited here.

It is worth noting that the exploration control is displayed in the region of the data analysis page corresponding to the first analysis result. The visualization canvas of the first analysis result is displayed on the exploration analysis page through the interactive operation on the exploration control to obtain the exploration analysis result of the first analysis result, where the visualization canvas is used to provide the data processing environment of the first analysis result. Therefore, in the case where the first analysis result does not meet the expectation, the first analysis result can be explored, analyzed, and verified through the exploration control and the visualization canvas to obtain the exploration analysis result. Then, the exploration analysis result is displayed on the data analysis page in response to the interactive operation on the return control on the exploration analysis page, to realize the synchronization of the data analysis result in the conversation interaction model and the exploration analysis model. Therefore, the accuracy of the data analysis result can be effectively improved.

In the present embodiment, a data analysis apparatus is further provided. The apparatus is used to implement the above embodiments and preferred implementations, which will not be repeated. As used below, the term “module” may implement a combination of software and/or hardware for a predetermined function. Although the apparatuses described in the following embodiments are preferably implemented in software, implementations in hardware, or a combination of software and hardware are also possible and contemplated.

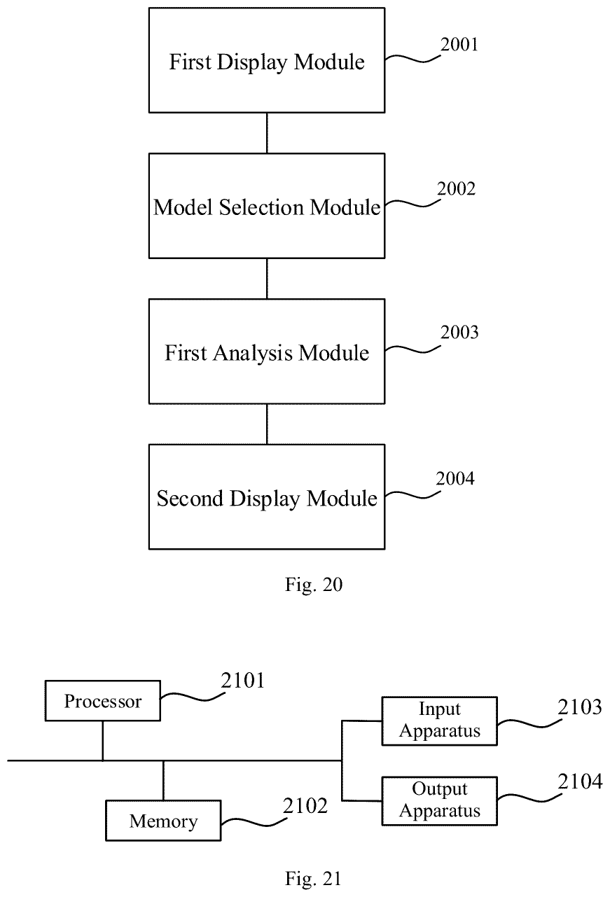

The present embodiment provides a data analysis apparatus, as shown in FIG. 20, including:
a first display module 2001, configured to display a data analysis page, where an analysis control is displayed on the data analysis page, and the analysis control corresponds to at least one language model;
a model selection module 2002, configured to determine a target language model in response to a selection instruction for the analysis control;
a first analysis module 2003, configured to generate a first data analysis instruction in response to a first question determined on the data analysis page, where the first data analysis instruction is used to determine a first analysis result of the target language model for the first question; and
a second display module 2004, configured to display the first analysis result on the data analysis page.

In some optional implementations, a target data source for data analysis and a recommended question corresponding to the target data source are further displayed on the data analysis page. In this case, the first analysis module 2003 includes:
a question selection unit, configured to determine the first question in response to a selection instruction for the recommended question; and
a first analysis unit, configured to generate the first data analysis instruction in response to the determined first question.

In some optional implementations, the data analysis apparatus of the present disclosure further includes:
a third display module, configured to display an optional dataset in response to an interactive operation for the target data source, where the optional dataset includes at least one of a public dataset and other permission datasets with access permission; and
a data source selection module, configured to update the target data source with a selected optional dataset in response to a selection instruction for the optional dataset.

In other optional implementations, the first analysis module 2003 includes:
a question determination unit, configured to determine an initial question in response to a question input into an input control on the data analysis page;
a question optimization unit, configured to determine the first question in response to an optimization instruction for the initial question; and
a second analysis unit, configured to generate the first data analysis instruction in response to the determined first question.

In some optional implementations, during the process of determining the first analysis result, a data analysis process of the target language model for the first question is displayed on the data analysis page.

In some optional implementations, a viewing control is also displayed in a region of the data analysis page corresponding to the first analysis result, the viewing control is used to view the data analysis process of the first analysis result, and the data analysis process includes at least one hierarchical data analysis element.

In some optional implementations, the data analysis apparatus of the present disclosure further includes:
a fourth display module, configured to display at least one hierarchical data analysis element on a details page in response to an interactive operation on the viewing control;
a data modification module, configured to determine a modified data analysis element in response to a modification instruction for the at least one hierarchical data analysis element; and
a fifth display module, configured to display an analysis result corresponding to the modified data analysis element on the data analysis page.

In some optional implementations, at least one first display control is further displayed on the details page, and the first display control is used to determine a display manner of the at least one hierarchical data analysis element on the details page.

In some optional implementations, the data analysis apparatus of the present disclosure further includes:
an analysis data selection module, configured to determine a target analysis object in response to a selection instruction for first data in the first analysis result and/or second data in a historical analysis result;
a second analysis module, configured to generate a second data analysis instruction in response to a second question input into an input control on the data analysis page, where the second data analysis instruction is used to determine a second analysis result of the target language model for the second question and the target analysis object; and
a sixth display module, configured to display the second analysis result on the data analysis page.

In some optional implementations, the upload control is further displayed on the data analysis page, and the upload control is used to upload the target content. In this case, the data analysis apparatus of the present disclosure further includes:
a data upload module, configured to determine the target content in response to an interactive operation on the upload control;
a third analysis module, configured to generate a third data analysis instruction in response to a third question input into the input control on the data analysis page, where the third data analysis instruction is used to determine a third analysis result of the target language model for the third question and the target content; and
a seventh display module, configured to display the third analysis result on the data analysis page.

In some optional implementations, a save control is also displayed in area region of the data analysis page corresponding to the first analysis result, and the save control is used to store the first question and/or the first analysis result.

In some optional implementations, the data analysis apparatus of the present disclosure further includes:
a task subscription module, configured to display a task subscription page in response to an interactive operation on the save control, where the task subscription page is used to store the first question to obtain a target subscription task of the first question;
a push generation module, configured to generate push content in response to a fourth analysis result fed back for the target subscription task; and
a data push module, configured to push the push content to a target push object.

In some optional implementations, the data analysis page includes a first display region for displaying the first question and the first analysis result, and a second display region for displaying a storage result corresponding to the save control.

In some optional implementations, the data analysis apparatus of the present disclosure further includes:
a data summary module, configured to display summary content of a selected storage result in the first display region in response to a selection instruction for the storage result.

In some optional implementations, at least one second display control is displayed in the second display region, and the second display control is used to determine a display manner of the storage result in the second display region.

Further functional description of the above-mentioned modules and units is the same as that of the above corresponding embodiments, which will not be repeated here.

The data analysis apparatus in this embodiment is presented in the form of functional units, where the unit refers to an ASIC (Application Specific Integrated Circuit) circuit, a processor and a memory that execute one or more software or fixed programs, and/or other devices that can provide the above functions.

The embodiments of the present disclosure further provide an electronic device, which includes the above data analysis apparatus shown in FIG. 20.

Referring to FIG. 21, FIG. 21 is a block diagram of an electronic device according to an optional embodiment of the present disclosure. As shown in FIG. 21, the electronic device includes: one or more processors 2101, a memory 2102, and interfaces for connecting various components, including a high-speed interface and a low-speed interface. Various components are in communication connection with each other by using different buses and can be installed on a common motherboard or in other manners as required. The processor may process instructions executed within the electronic device, and the instructions include instructions stored in the memory or on the memory to display graphic information of a GUI on an external input/output apparatus (such as a display device coupled to the interface). In some optional implementations, a plurality of processors and/or a plurality of buses may be used together with a plurality of memories, if required. Similarly, a plurality of electronic devices may be connected, and each device provides part of necessary operations (for example, as a server array, a group of blade servers, or a multi-processor system). In FIG. 21, one processor 2101 is taken as an example.

The processor 2101 may be a central processing unit, a network processor, or a combination thereof. The processor 2101 may further include a hardware chip. The above hardware chip may be an application specific integrated circuit, a programmable logic device, or a combination thereof. The above programmable logic device may be a complex programmable logic device, a field programmable logic gate array, a generic array logic, or any combination thereof.

The memory 2102 stores instructions that can be executed by at least one processor 2101 to enable the at least one processor 2101 to perform the method shown in the above embodiments.

The memory 2102 may include a program storage region and a data storage region, where the program storage region may store an operating system and applications required for at least one function; and the data storage region may store data created according to the use of the electronic device. In addition, the memory 2102 may include a high-speed random access memory, and may also include a non-transitory memory, such as at least one magnetic disk storage device, a flash memory device, or other non-transitory solid-state storage device. In some optional implementations, the memory 2102 may optionally include a memory remotely provided relative to the processor 2101, and these remote memories may be connected to the electronic device through a network. Examples of the above network include but are not limited to the Internet, an intranet, a local area network, a mobile communication network, and a combination thereof.

The memory 2102 may include a volatile memory, such as a random access memory; the memory may also include a non-volatile memory, such as a flash memory, a hard disk or a solid-state disk; and the memory 2102 may also include a combination of the above-mentioned types of memories.

The electronic device further includes an input apparatus 2103 and an output apparatus 2104. The processor 2101, the memory 2102, the input apparatus 2103 and the output apparatus 2104 can be connected through a bus or in other manners, and FIG. 21 shows an example of connection through a bus.

The input apparatus 2103 can receive input digital or character information, and generate key signal inputs related to user settings and function control of the electronic device, such as a touchscreen, a keypad, a mouse, a trackpad, a touchpad, an indicator bar, one or more mouse buttons, a trackball, a joystick, etc. The output apparatus 2104 may include a display device, an auxiliary lighting apparatus (for example, an LED), a tactile feedback apparatus (for example, a vibration motor), etc. The above display device includes but is not limited to a liquid crystal display, a light emitting diode, a display, and a plasma display. In some optional implementations, the display device may be a touchscreen.

The embodiments of the present disclosure further provide a computer-readable storage medium, the method according to the embodiments of the present disclosure may be implemented in hardware and firmware, or may be implemented as computer code that can be recorded in a storage medium, or may be implemented as computer code downloaded over a network, which is originally stored in a remote storage medium or a non-transitory machine-readable storage medium and will be stored in a local storage medium, so that the method described herein may be stored in such software processing on a storage medium using a general-purpose computer, a special-purpose processor, or programmable or special-purpose hardware. The storage medium may be a magnetic disk, an optical disk, a read-only memory, a random access memory, a flash memory, a hard disk, a solid-state disk, or the like; further, the storage medium may also include a combination of the above-mentioned types of memories. It can be understood that a computer, a processor, a microprocessor controller, or programmable hardware includes a storage component that can store or receive software or computer code, and when the software or computer code is accessed and executed by the computer, the processor, or the hardware, the method shown in the above embodiments is implemented.

A part of the present disclosure may be applied as a computer program product, such as computer program instructions, which, when executed by a computer, can call or provide the method and/or technical solutions according to the present disclosure through the operation of the computer. Those of ordinary skills in the art should understand that the existence form of computer program instructions in a computer-readable medium includes but is not limited to source files, executable files, installation package files, etc. Correspondingly, the manner in which the computer program instructions are executed by the computer includes but is not limited to: the computer directly executes the instructions, or the computer compiles the instructions and then executes the corresponding compiled program, or the computer reads and executes the instructions, or the computer reads and installs the instructions and then executes the corresponding installed program. Here, the computer-readable medium may be any available computer-readable storage medium or communication medium that can be accessed by the computer.

Although the embodiments of the present disclosure have been described with reference to the drawings, those of ordinary skills in the art may make various modifications and variations without departing from the spirit and scope of the present disclosure, and such modifications and variations fall within the scope defined by the appended claims.

1. A data analysis method, comprising:
displaying a data analysis page, wherein an analysis control is displayed on the data analysis page, and the analysis control corresponds to at least one language model;
determining a target language model in response to a selection instruction for the analysis control;
generating a first data analysis instruction in response to a first question determined on the data analysis page, wherein the first data analysis instruction is used to determine a first analysis result of the target language model for the first question; and
displaying the first analysis result on the data analysis page.

2. The data analysis method according to claim 1, wherein a target data source for data analysis and a recommended question corresponding to the target data source are further displayed on the data analysis page; and the generating the first data analysis instruction in response to the first question determined on the data analysis page comprises:
determining the first question in response to a selection instruction for the recommended question; and
generating the first data analysis instruction in response to the determined first question.

3. The data analysis method according to claim 2, further comprising:
displaying an optional dataset in response to an interactive operation for the target data source, wherein the optional dataset comprises at least one of a public dataset and other permission datasets with access permission; and
updating the target data source with a selected optional dataset in response to a selection instruction for the optional dataset.

4. The data analysis method according to claim 1, wherein the generating the first data analysis instruction in response to the first question determined on the data analysis page comprises:
determining an initial question in response to a question input into an input control on the data analysis page;
determining the first question in response to an optimization instruction for the initial question; and
generating the first data analysis instruction in response to the determined first question.

5. The data analysis method according to claim 1, wherein during a process of determining the first analysis result, a data analysis process of the target language model for the first question is displayed on the data analysis page.

6. The data analysis method according to claim 1, wherein a viewing control is further displayed in a region of the data analysis page corresponding to the first analysis result, the viewing control is used to view a data analysis process of the first analysis result, and the data analysis process comprises at least one hierarchical data analysis element.

7. The data analysis method according to claim 6, further comprising:
displaying the at least one hierarchical data analysis element on a details page in response to an interactive operation on the viewing control;
determining a modified data analysis element in response to a modification instruction for the at least one hierarchical data analysis element; and
displaying an analysis result corresponding to the modified data analysis element on the data analysis page.

8. The data analysis method according to claim 7, wherein at least one first display control is further displayed on the details page, and the first display control is used to determine a display manner of the at least one hierarchical data analysis element on the details page.

9. The data analysis method according to claim 1, further comprising:
determining a target analysis object in response to a selection instruction for first data in the first analysis result and/or second data in a historical analysis result;
generating a second data analysis instruction in response to a second question input into an input control on the data analysis page, wherein the second data analysis instruction is used to determine a second analysis result of the target language model for the second question and the target analysis object; and
displaying the second analysis result on the data analysis page.

10. The data analysis method according to claim 1, wherein an upload control is further displayed on the data analysis page, and the upload control is used to upload target content; and the method further comprises:
determining the target content in response to an interactive operation on the upload control;
generating a third data analysis instruction in response to a third question input into an input control on the data analysis page, wherein the third data analysis instruction is used to determine a third analysis result of the target language model for the third question and the target content; and
displaying the third analysis result on the data analysis page.

11. The data analysis method according to claim 1, wherein a save control is further displayed in a region of the data analysis page corresponding to the first analysis result, and the save control is used to store the first question and/or the first analysis result.

12. The data analysis method according to claim 11, further comprising:
displaying a task subscription page in response to an interactive operation on the save control, wherein the task subscription page is used to store the first question to obtain a target subscription task of the first question;
generating push content in response to a fourth analysis result fed back for the target subscription task; and
pushing the push content to a target push object.

13. The data analysis method according to claim 11, wherein the data analysis page comprises a first display region for displaying the first question and the first analysis result, and a second display region for displaying a storage result corresponding to the save control.

14. The data analysis method according to claim 13, further comprising:
displaying summary content of a selected storage result in the first display region in response to a selection instruction for the storage result.

15. The data analysis method according to claim 13, wherein at least one second display control is displayed in the second display region, and the second display control is used to determine a display manner of the storage result in the second display region.

16. An electronic device, comprising:
a memory and a processor, wherein the memory and the processor are in communication connection with each other, the memory stores computer instructions, and the processor executes the computer instructions to perform a data analysis method; and the data analysis method comprises:
displaying a data analysis page, wherein an analysis control is displayed on the data analysis page, and the analysis control corresponds to at least one language model;
determining a target language model in response to a selection instruction for the analysis control;
generating a first data analysis instruction in response to a first question determined on the data analysis page, wherein the first data analysis instruction is used to determine a first analysis result of the target language model for the first question; and
displaying the first analysis result on the data analysis page.

17. The electronic device according to claim 16, wherein a target data source for data analysis and a recommended question corresponding to the target data source are further displayed on the data analysis page; and the generating the first data analysis instruction in response to the first question determined on the data analysis page comprises:
determining the first question in response to a selection instruction for the recommended question; and
generating the first data analysis instruction in response to the determined first question.

18. The electronic device according to claim 17, wherein the data analysis method further comprises:
displaying an optional dataset in response to an interactive operation for the target data source, wherein the optional dataset comprises at least one of a public dataset and other permission datasets with access permission; and
updating the target data source with a selected optional dataset in response to a selection instruction for the optional dataset.

19. The electronic device according to claim 16, wherein the generating the first data analysis instruction in response to the first question determined on the data analysis page comprises:
determining an initial question in response to a question input into an input control on the data analysis page;
determining the first question in response to an optimization instruction for the initial question; and
generating the first data analysis instruction in response to the determined first question.

20. A non-transitory computer-readable storage medium, storing computer instructions, wherein the computer instructions are used to enable a computer to perform a data analysis method, and the data analysis method comprises:
displaying a data analysis page, wherein an analysis control is displayed on the data analysis page, and the analysis control corresponds to at least one language model;
determining a target language model in response to a selection instruction for the analysis control;
generating a first data analysis instruction in response to a first question determined on the data analysis page, wherein the first data analysis instruction is used to determine a first analysis result of the target language model for the first question; and
displaying the first analysis result on the data analysis page.
